(19) United States
(12) Patent Application Publication
(10) Pub. No.: US 2002/0083465 A1
(43) Pub. Date: Jun. 27, 2002

(54) CATV system

(76) Inventor: Willem Jan Douwe Van Beek, Eindhoven (NL)

Correspondence Address: U.S. Philips Corporation, 580 White Plains Road, Tarrytown, NY, 10591, US

(21) Appl. No.: 09/963,631

(22) Filed: Sep. 26, 2001

(30) Foreign Application Priority Data
Sep. 29, 2000 (EP) 00203383.5

(51) Int. Cl. H04N 7/173

(52) U.S. Cl. 725/119; 725/111; 725/98

(57) ABSTRACT

The CATV system (8) according to the invention comprises a primary station (2) and a secondary station (4). The CATV system (8) has a frequency band (12) with a plurality of substantially equally spaced and sized frequency channels (10). The CATV system (8) is arranged for transmitting data signals in at least part of the frequency channels (10) from the primary station (2) to the secondary station (4). The secondary station (4) comprises acquire means for acquiring a frequency channel (10) in which at least part of the data signals are transmitted. The acquire means are arranged for scanning the frequency band (12) in frequency steps which are substantially equal to the size of the frequency channels (10) from a starting frequency until a frequency channel (10) carrying data signals is found. In this way it is possible to acquire a frequency channel (10) relatively fast.

The invention relates to a CATV system comprising a primary station and a secondary station, the CATV system having a frequency band with a plurality of substantially equally spaced and sized frequency channels, the CATV system being arranged for transmitting data signals in at least part of the frequency channels from the primary station to the secondary station, the secondary station comprising acquire means for acquiring a frequency channel in which at least part of the data signals are transmitted, the acquire means being arranged for scanning the frequency band in frequency steps from a starting frequency until a frequency channel carrying data signals is found.

The invention also relates to a secondary station for receiving data signals in a frequency band from a primary station, the frequency band having a plurality of substantially equally spaced and sized frequency channels, the data signals being received in at least part of the frequency channels, the secondary station comprising acquire means for acquiring a frequency channel carrying at least part of the data signals, the acquire means being arranged for scanning the frequency band in frequency steps from a starting frequency until a frequency channel carrying data signals is found.

The invention further relates to a method of acquiring a frequency channel carrying data signals, the frequency channel being comprised in a frequency band with a plurality of substantially equally spaced and sized frequency channels, the method comprising the step of scanning the frequency band in frequency steps from a starting frequency until a frequency channel carrying data signals is found.

A CATV system according to the preamble is known from the document entitled “Data-Over-Cable Service Interface Specifications, Radio Frequency Interface Specification, SP-RFIv1.1-WO1-981008”. This document describes a so-called DOCSIS compliant CATV system comprising a cable modem termination system (CMTS) as (part of) a primary station and cable modems (CM) as (part of) secondary stations. Cable modems are devices that allow high-speed data access to e.g. the Internet via a cable television (CATV) network. While similar in some respects to a traditional analog modem, a cable modem is significantly more powerful, capable of delivering data approximately 500 times faster. Current Internet access via a 28.8-, 33.6-, or 56-kbps modem is referred to as voiceband modem technology. Like voiceband modems, cable modems modulate and demodulate data signals. However, cable modems incorporate more functionality suitable for today's high-speed Internet services. In a CATV system, data from the CATV network to the user is referred to as downstream, whereas data from the user to the CATV network is referred to as upstream. From a user perspective, a DOCSIS-compliant cable modem is a 64/256 QAM RF receiver capable of delivering up to 30 to 40 Mbps of data in one 6-MHz cable channel. This is approximately 500 times faster than a 56-kbps modem. Data from a user to the network is sent in a flexible and programmable system under control of the headend or primary station. The data is modulated using a QPSK/16 QAM transmitter with data rates from 320 kbps up to 10 Mbps.

Because some cable networks are suited for broadcast television services, cable modems may use either a standard telephone line or a QPSK/16 QAM modem over a two-way cable system to transmit data upstream from a user location to the network. When a telephone line is used in conjunction with a one-way broadcast network, the cable data system is referred to as a telephony return interface (TRI) system. In this mode, a satellite or wireless cable television network can also function as a data network.

At the cable headend, data from individual users is filtered by upstream demodulators (or telephone-return systems, as appropriate) for further processing by a cable modem termination system (CMTS). A CMTS is a data switching system specifically designed to route data from many cable modem users over a multiplexed network interface. Likewise, a CMTS receives data from the Internet and provides data switching necessary to route data to the cable modem users. Data from the network to a user group is sent to a 64/256 QAM modulator. The result is user data modulated into one 6-MHz channel, which is the spectrum allocated for a cable television channel such as ABC, NBC, or TBS for broadcast to all users.

A cable headend combines the downstream data channels with the video, pay-per-view, audio, and local advertiser programs that are received by television subscribers. The combined signal is then transmitted throughout the cable distribution network. At the user location, the television signal is received by a set-top box, while user data is separately received by a cable modem box and sent to a PC.

The known CATV system has, in the downstream direction, a frequency passband comprising a plurality of substantially equally spaced and sized (6 MHz) frequency channels. This frequency band has a lower edge between 50 and 54 MHz and an upper edge that is implementation-dependent but is typically in the range of 300 to 864 MHz. Within that frequency band, (NTSC) analog television signals may be present, as well as other narrowband and wideband digital signals. All these signals are transmitted in 6-MHz frequency channels. Some of these frequency channels may carry data signals which are of interest for the secondary stations. On initialization or after signal loss, a secondary station has to acquire such a downstream frequency channel. For this purpose, the secondary station has acquire means which has non-volatile storage in which the last operational parameters (related to the last used downstream frequency channel) are stored and which first tries to reacquire this downstream frequency channel (the starting frequency). If this fails, the acquire means must begin to continuously scan the downstream frequency band until it finds a valid downstream frequency channel. A valid downstream frequency channel is a downstream frequency channel which carries a downstream data signal and for which the secondary station was able to synchronize the QAM symbol timing, synchronize the FEC framing, synchronize the MPEG packetization and to recognize the SYNC downstream MAC messages. This process of scanning the downstream frequency band until a valid downstream frequency channel is found may take a considerable time, e.g. up to more than 1 hour. The known CATV system handles the process of acquiring a downstream frequency channel in a relatively inefficient and time-consuming way.

It is an object of the invention to provide a CATV system, which handles the process of acquiring a downstream frequency channel in a more efficient and time-effective way. This object is achieved in the CATV system according to the invention, which is characterized in that the frequency steps are substantially equal to the bandwidth of the frequency channels. The invention is based upon the recognition that the known process of acquiring a downstream frequency channel by scanning the frequency band in relatively small frequency steps (of e.g. 200-250 kHz) is very time consuming because of the following: FIG. 3 shows a frequency channel 10 which is centered around a center frequency of 400 MHz. The lower edge of this 6 MHz sized frequency channel 10 is located at approximately 397 MHz. The upper edge of this frequency channel 10 is located at approximately 403 MHz. The frequency channel 10 is divided in three different regions 20, 22 and 24, which regions are symmetrically located around the center frequency. Region 20 is located near the lower and upper edges of the frequency channel 10, region 24 is located near the center frequency and region 22 is located in between the regions 20 and 24. The quality of a signal within a frequency channel 10 is frequency dependent in such a way that within region 24 the acquire means are able to acquire the frequency channel 10 relatively fast because the quality of the data signal is good within this region 24. Furthermore, the quality of the data signal in the region 20 is so bad that the acquire means can quickly determine that it is not possible to acquire a frequency channel. Within the region 22 the quality of the data signal is not good enough for the acquire means to acquire a frequency channel but the quality is also not bad enough for the acquire means to quickly decide that it is not possible to lock on to this frequency. Experiments have shown that it may take up to 30 minutes for a frequency within the region 22 before the acquire means has found that it cannot acquire a frequency channel 10 at this frequency. By using frequency steps which are substantially equal to the bandwidth of the frequency channels 10 the acquire means can avoid the regions 22 within the frequency channels 10, avoiding the time-consuming attempts to acquire a frequency channel 10 at frequencies within the regions 22. The starting frequency usually is positioned within the region 24 of a frequency channel 10. The starting frequency may be the last known good frequency or a preprogrammed frequency. If it is not possible to acquire a frequency channel 10 at the starting frequency the acquire means can try to acquire a frequency channel 10 at a frequency which is equal to the starting frequency plus 6 MHz, etc. The frequency channels 10 are usually positioned very close to one another in the frequency band 12 (see FIG. 2). Hence, by stepping through the frequency band 12 in frequency steps which are substantially equal to the bandwidth of the frequency channels 10 (e.g. 6 MHz as in the case of the known CATV system) the acquire means are likely to step from a region 24 in a first frequency channel 10 to a region 24 in another frequency channel 10, avoiding the regions 22.

An embodiment of the CATV system according to the invention is characterized in that the acquire means are arranged for decreasing the size of the frequency steps when no frequency channel carrying data signals can be found. When it is not possible to acquire a frequency channel by stepping through the frequency band with the relatively large frequency steps as discussed above (for example because the starting frequency was not located within a region 24 of a frequency channel) it is still possible to locate and acquire a frequency channel by scanning the frequency band in relatively small frequency steps of, for example, 200-250 kHz.

An embodiment of the CATV system according to the invention is characterized in that the primary station comprises a cable modem termination system and in that the secondary station comprises a cable modem. The invention may be advantageously used in a CATV system which supports the use of cable modems. In such a system, the primary station may be a head end which comprises a cable modem termination system and the secondary stations may be stand-alone cable modems or set-top boxes and television receivers having an integrated cable modem. The cable modem and the cable modem termination system may comply to the DOCSIS-standard (as described in the above document) or to the so-called EURO-DOCSIS-standard or to the DVB-RC standard.

The above object and features of the present invention will be more apparent from the following description of the preferred embodiments with reference to the drawings, wherein:

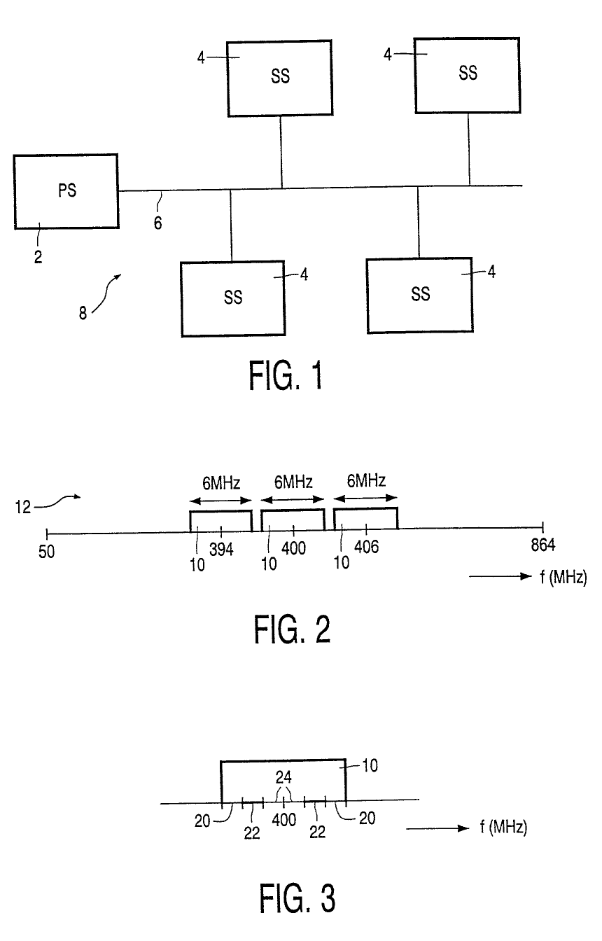

FIG. 1 shows a block diagram of an embodiment of the CATV system according to the invention,

FIG. 2 shows schematically a frequency band with a plurality of frequency channels,

FIG. 3 shows schematically a frequency channel.

In the Figures, identical parts are provided with the same reference numbers.

The CATV system 8 according to FIG. 1 comprises a primary station or head end 2 and a plurality of secondary stations or network terminations 4. The primary station 2 and the secondary stations 4 are interconnected via a CATV network 6. The CATV network may be a hybrid fibre/coax network or HFC network. The primary station 2 may comprise a cable modem termination system (CMTS) and the secondary stations 4 may comprise cable modems (CM). The CMTS and the CMs may be DOCSIS-, EURO-DOCSIS or DVB-RC compliant. The CATV system 8 has, in the downstream direction, a frequency passband 12 comprising a plurality of substantially equally spaced and sized (6 MHz) frequency channels 10 (see FIG. 2 showing three frequency channels 10 centered around 394, 400 and 406 MHz, respectively). This frequency band 12 has a lower edge of 50 MHz and an upper edge of 864 MHz. Within that frequency band 12, (NTSC) analog television signals may be present, as well as other narrowband and wideband digital signals. All these signals are transmitted in 6-MHz frequency channels. Some of these frequency channels may carry data signals which are transmitted from the primary station 2 to (at least part of) the secondary stations 4. On initialization or after signal loss, a secondary station 4 has to acquire such a downstream frequency channel. For this purpose, the secondary station has acquire means (not shown) which has non-volatile storage in which the last operational parameters (related to the last used downstream frequency channel or a preprogrammed frequency) are stored and which first tries to re-acquire this downstream frequency channel (the starting frequency). If this fails, the acquire means must begin to continuously scan the downstream frequency band until it finds a valid downstream frequency channel. A valid downstream frequency channel is a downstream frequency channel which carries a downstream data signal and for which the secondary station was able to synchronize the QAM symbol timing, synchronize the FEC framing, synchronize the MPEG packetization and to recognize the SYNC downstream MAC messages.

The acquire means scan the frequency band 12 in frequency steps which are substantially equal to the bandwidth of the frequency channels, i.e. 6 MHz in this example, from a starting frequency until a frequency channel 10 carrying data signals is found. In other implementations of the CATV system according to the invention the bandwidth of the frequency channels may be different, i.e. 8 MHz, and the frequency steps have accordingly a different value.

When it is not possible to acquire a frequency channel 10 by stepping through the frequency band 12 with the relatively large frequency steps as discussed above (for example because the starting frequency was not located within a region 24 of a frequency channel) it is still possible to locate and acquire a frequency channel 10 by scanning the frequency band in relatively small frequency steps of, for example, 200-250 kHz. Hence, the acquire means decrease the size of the frequency steps when no frequency channel carrying data signals is found.

The scope of the invention is not limited to the embodiments explicitly disclosed. The invention is embodied in each new characteristic and each combination of characteristics. Any reference signs do not limit the scope of the claims. The word “comprising” does not exclude the presence of other elements or steps than those listed in a claim. Use of the word “a” or “an” preceding an element does not exclude the presence of a plurality of such elements.

1. A CATV system (8) comprising a primary station (2) and a secondary station (4), the CATV system (8) having a frequency band (12) with a plurality of substantially equally spaced and sized frequency channels (10), the CATV system (8) being arranged for transmitting data signals in at least part of the frequency channels (10) from the primary station (2) to the secondary station (4), the secondary station (4) comprising acquire means for acquiring a frequency channel (10) in which at least part of the data signals are transmitted, the acquire means being arranged for scanning the frequency band (12) in frequency steps from a starting frequency until a frequency channel (10) carrying data signals is found, characterized in that the frequency steps are substantially equal to the bandwidth of the frequency channels (10).

2. The CATV system (8) according to claim 1, characterized in that the acquire means are arranged for decreasing the size of the frequency steps when no frequency channel (10) carrying data signals can be found.

3. The CATV system (8) according to claim 1 or 2, characterized in that the primary station (2) comprises a cable modem termination system and in that the secondary station (4) comprises a cable modem.

4. The CATV system (8) according to claim 3, characterized in that the cable modem termination system and the cable modem are DOCSIS-compliant.

5. A secondary station (4) for receiving data signals in a frequency band (12) from a primary station (2), the frequency band (12) having a plurality of substantially equally spaced and sized frequency channels (10), the data signals being received in at least part of the frequency channels (10), the secondary station (4) comprising acquire means for acquiring a frequency channel (10) carrying at least part of the data signals, the acquire means being arranged for scanning the frequency band (12) in frequency steps from a starting frequency until a frequency channel (10) carrying data signals is found, characterized in that the frequency steps are substantially equal to the bandwidth of the frequency channels (10).

6. The secondary station (4) according to claim 5, characterized in that the acquire means are arranged for decreasing the size of the frequency steps when no frequency channel (10) carrying data signals can be found.

7. The secondary station (4) according to claim 5 or 6, characterized in that the secondary station (4) comprises a cable modem.

8. The secondary station (4) according to claim 7, characterized in that the cable modem is a DOCSIS-compliant cable modem.

9. A method of acquiring a frequency channel (10) carrying data signals, the frequency channel (10) being comprised in a frequency band (12) with a plurality of substantially equally spaced and sized frequency channels (10), the method comprising the step of scanning the frequency band (12) in frequency steps from a starting frequency until a frequency channel (10) carrying data signals is found, characterized in that the frequency steps are substantially equal to the bandwidth of the frequency channels (10).

10. The method according to claim 9, characterized in that the method further comprises the step of decreasing the size of the frequency steps when no frequency channel (10) carrying data signals can be found.
